(19) United States
(12) Patent Application Publication
(10) Pub. No.: US 2007/0186432 A1
(43) Pub. Date: Aug. 16, 2007

(54) Measuring device for linear position recording

(76) Inventors: Jens Hauch, Erlangen (DE); Klaus Ludwig, Erlangen (DE)

Correspondence Address: YOUNG & THOMPSON, 745 SOUTH 23RD STREET, 2ND FLOOR, ARLINGTON, VA, 22202, US

(21) Appl. No.: 10/591,319

(22) PCT Filed: Feb. 14, 2005
(86) PCT No.: PCT/EP05/50631

§ 371 Date: Oct. 31, 2006

(30) Foreign Application Priority Data
Mar. 1, 2004 (DE) 102004009868.9

(51) Int. Cl. G01B 7/00

(52) U.S. Cl. 33/708

(57) ABSTRACT

The measuring device (5), for a linear non-contact recording of the position of a movable object, comprises a field device (6), generating a magnetic field, which undergoes a displacement (x), from a reference position (xo), along a measuring run (2), corresponding to the movement of the object. The measuring run (2) is formed from a strip-like track (3) with magneto-resistive properties, contacting on the longitudinal side with resistance tracks (4a, 4b) made from normal resistive material. Connectors (A to D) are provided at the ends of the resistive tracks (4a, 4b) at which measured signals correlated to the position (x) of the field device (6) can be tapped.

The invention relates to a measurement device for linear, non-contacting recording of the position of a variable-position object having a field device, which is rigidly connected to the object, produces a magnetic field and is deflected, corresponding to the change in the position of the object, from a reference position along a measurement path. A corresponding measurement device is disclosed in DE 100 44 839 A1.

Various measurement devices are known for non-contacting linear position measurement of relatively great lengths, in particular of more than 0.5 cm. By way of example, the DE-A1 document cited in the introduction discloses a position sensor which has a field device which can be passed over a conductor-loop device and produces magnetic fields. The loop device in this case has at least one coil with conductor turns which surround one another and with an external contour which tapers from a broad face to a narrow face, and has an extent which is matched to the deflection of the field device, as well as being covered by a soft-magnetic layer. Means are provided for signal evaluation of the signals which are obtained from the loop device and are dependent on the change in the magnetic saturation.

The company prospectus from the company Tyco Electronics (CH) discloses a so-called PLCD (Permanentmagnetic Linear Contactless Displacement) position sensor, which has two coils with a soft-magnetic core and a transmitter magnet. In this case, the evaluation is carried out by a dedicated ASIC (Application Specific Integrated Circuit). The known position sensor must in this case have an extent which is at least twice as great as the measurement path. Its design is relatively complex, in the same way as the measurement device according to the DE-A1 document that was cited in the introduction.

The object of the present invention is therefore to refine the measurement device having the features cited in the introduction such that its design is simpler than that of the prior art.

According to the invention, this object is achieved by the features specified in claim 1. The measurement device defined in the introduction should accordingly be modified such that its measurement path is formed by a track which is in the form of a strip and has magnetoresistive characteristics, which track makes contact on each of its two opposite longitudinal faces with a resistance track composed of normal resistive material, with the normal resistive material being provided at the ends of the measurement path with connections, between which measurement signals which are correlated with the position of the field device can be tapped off.

In the measurement device according to the invention, the magnetoresistive material is locally saturated by the field device at the respective measurement position, thus correspondingly reducing the resistance of the conductor track in this area. The respective position of the field device can then be determined by measurement of the resistances between the individual connections, in a simple manner.

The advantages of this embodiment of the measurement device are a simple determination of the measurement values by the measurement of resistances, a flat design, and a length which is at least approximately the same as the extent of the measurement path.

Advantageous refinements of the measurement device according to the invention are specified in the claims dependent on claim 1. In this case, the embodiment as claimed in claim 1 can be combined with the features of one of the dependent claims, or also preferably with those from a plurality of dependent claims.

The measurement device may accordingly additionally also have the following features:
The track which is in the form of a strip and is composed of the magnetoresistive material can thus have a magnetoresistive layer system corresponding to an XMR or CMR element.
Instead of this, the track which is in the form of a strip may also have at least one layer composed of a granular magnetoresistive material, or a magnetoresistive suspension.
In particular, the two longitudinal-face resistance tracks may extend over the entire linear extent of the measurement path.
The linear extent of the measurement path may in this case advantageously be more than 0.5 cm.

The invention will be explained in more detail in the following text on the basis of one preferred exemplary embodiment and with reference to the drawing, in which, in this case:

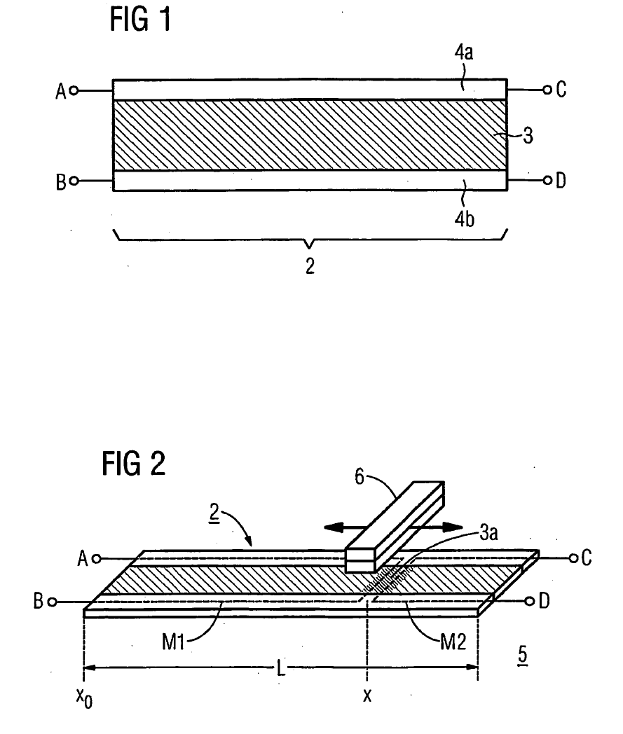

FIG. 1 shows a view of a measurement path of a measurement device according to the invention, and

FIG. 2 shows an oblique view of a measurement device with the measurement path as shown in FIG. 1.

In this case, mutually corresponding parts in the figures are in each case provided with the same reference symbols.

The design of a measurement device according to the invention is based on embodiments which are known per se. Only those parts which are refined according to the invention will be described in the following text. All the other parts are prior art in this context.

As shown in FIG. 1, a measurement path 2 of a measurement device according to the invention has a track 3 in the form of a strip composed of magnetoresistive material. In particular, this could be done using layer systems such as those known from XMR thin-film elements or CMR thin-film elements (see, for example, the volume “XMR technology” Technology analysis: magnetism; Vol. 2, VDI Technology Center “Physical technologies”, Dusseldorf (DE), 1997, pages 11 to 46. However, it is also possible to use any other material whose conductivity changes as a function of a magnetic field. Thus, for example, granular magnetic materials are known (see, for example, DE 44 25 356 C2). Suspensions are also possible in order to form a corresponding layer, which have very small particles, distributed in a dispersed form in a liquid medium, with magnetic and electrical characteristics, for example composed of the abovementioned granular material. A strip or a track 4a or 4b, respectively, composed of a normal resistive material is fitted, such that it is electrically conductively connected, on each of the two opposite longitudinal faces of the track 3. These resistance tracks are provided with respective electrical connections A, C and B, D at the opposite ends of the measurement path.

FIG. 2 shows a measurement device 5 with the measurement path 2 that is shown in FIG. 1 and has a linear extent or length L. The device 5 has a field device, which produces a magnetic field, in particular in the form of a transmitter magnet 6. This transmitter magnet can be moved over the preferably entire extent L of the measurement path 2, in particular over more than 0.5 cm, without any touching contact, in the longitudinal direction. It is rigidly connected to an object which will not be described in any more detail but whose position is intended to be recorded with respect to the measurement path. The position in this case corresponds to a deflection x with respect to a reference position x₀. The magnetoresistive material of the track 3 which is in the form of a strip is saturated in an area 3a at the measurement position x by the transmitter magnet 6, so that the resistance is correspondingly reduced at this point. A connection with reduced resistance is thus created over this area 3a, between the resistance tracks 4a and 4b.

For position recording, resistance measurements are carried out between the measurement connections A and B, as well as C and D. The corresponding measurement paths are illustrated by dashed lines M1 and M2, respectively, in FIG. 2. Furthermore, the resistance between the connections A and D or B and C can also be measured, as a third current path. The position x of the transmitter magnet can then be determined unambiguously from the corresponding three measurement values. If required, an advantageous design of the measurement device means that only the values from the two measurement paths M1 and M2 will be sufficient for position determination.

In the case of the measurement device 5 according to the invention, that part which is covered linearly by the transmitter magnet 6 is regarded as the linear extent L of the measurement path 2, that is to say the resistance tracks 4a and 4b and/or the magnetoresistive track 3 may have a length which is not the same as the extent L.

1. A measurement device (5) for linear, non-contacting recording of the position of a variable-position object having a field device (6), which is rigidly connected to the object, produces a magnetic field and is deflected (x), corresponding to the change in the position of the object, from a reference position (x₀) along a measurement path (2), characterized in that the measurement path (2) is formed by a track (3) which is in the form of a strip and has magnetoresistive characteristics, which track (3) makes contact on each of its two opposite longitudinal faces with a resistance track (4a, 4b) composed of normal resistive material, with the normal resistive material being provided at the ends of the measurement path (2) with connections (A to D), between which measurement signals which are correlated with the position (x) of the field device (6) can be tapped off.

2. The device as claimed in claim 1, characterized in that the track (3) which is in the form of a strip and has magnetoresistive characteristics has a magnetoresistive layer system corresponding to an XMR or CMR element.

3. The device as claimed in claim 1, characterized in that the track (3) which is in the form of a strip and has magnetoresistive characteristics contains a layer with a granular magnetoresistive material.

4. The device as claimed in claim 1, characterized in that the track (3) which is in the form of a strip and has magnetoresistive characteristics has a layer which is formed from a suspension of particles with those characteristics.

5. The device as claimed in claim 1, characterized in that the two longitudinal-face resistance tracks (4a, 4b) extend over the entire linear extent (L) of the measurement path (2).

6. The device as claimed in claim 1, characterized by the measurement path (2) having a linear extent (L) of more than 0.5 cm.

7. The device as claimed in claim 2, characterized in that the two longitudinal-face resistance tracks (4a, 4b) extend over the entire linear extent (L) of the measurement path (2).

8. The device as claimed in claim 3, characterized in that the two longitudinal-face resistance tracks (4a, 4b) extend over the entire linear extent (L) of the measurement path (2).

9. The device as claimed in claim 4, characterized in that the two longitudinal-face resistance tracks (4a, 4b) extend over the entire linear extent (L) of the measurement path (2).

10. The device as claimed in claim 2, characterized by the measurement path (2) having a linear extent (L) of more than 0.5 cm.

11. The device as claimed in claim 3, characterized by the measurement path (2) having a linear extent (L) of more than 0.5 cm.

12. The device as claimed in claim 4, characterized by the measurement path (2) having a linear extent (L) of more than 0.5 cm.

13. The device as claimed in claim 5, characterized by the measurement path (2) having a linear extent (L) of more than 0.5 cm.
